(19) United States
(12) Patent Application Publication
(10) Pub. No.: US 2025/0367542 A1
(43) Pub. Date: Dec. 4, 2025

(54) KEY TRAVEL ADJUSTABLE SWITCH AND GAMING PERIPHERAL

(71) Applicant: QANBA USA, LLC, Daly City, CA (US)

(72) Inventors: Kai LIU, Daly City, CA (US); Jeffrey LYO, Daly City, CA (US)

(21) Appl. No.: 18/890,680

(22) Filed: Sep. 19, 2024

(30) Foreign Application Priority Data
May 30, 2024 (CN) 202421205948.6

(51) Int. Cl. A63F 13/24

(52) U.S. Cl. CPC A63F 13/24

(57) ABSTRACT

The present disclosure discloses a key travel adjustable switch. The key travel adjustable switch may include a snap fastener, a switch cap clamped to the snap fastener and having a travel positioning portion, a switch cap silicone between the switch cap and the snap fastener; and a switch body having a plurality of travel adjusting portions of different heights. A key travel of the key travel adjustable switch may be adjustable by positioning the travel positioning portion at different travel adjusting portions of different heights. When the key travel adjustable switch is in use, by prying open a matching structure of a travel positioning portion of the switch cap and the travel adjusting portion on the switch body, by a rotation of the switch cap and/or the switch body at a certain angle, the travel positioning portion may match with a different travel adjusting portion to adjust the key travel.

### CROSS-REFERENCE TO RELATED APPLICATION(S)

The present application claims priority to and the benefit of Chinese Patent Application No. 202421205948.6, filed on May 30, 2024, in China National Intellectual Property Administration, the entire disclosure of which is incorporated herein by reference.

### TECHNICAL FIELD

The present disclosure relates to the field of a switch, a gaming peripheral including the switch, and in particular to a key travel adjustable switch.

### BACKGROUND

Currently, in the field of gaming peripherals, a trigger travel of a gaming key/switch for triggering an action is single and fixed in most cases. It is troublesome to use the key/switch which adjusts the trigger travel for triggering the action by means of a driver, a physical key travel of the key/switch does not change with the change in the trigger travel for triggering the action, and consequently a user does not have a direct feeling. With the development of e-sports games, the user has higher and higher requirements for gaming peripherals, for example, a quick response is needed when the key/switch is pressed. However, the current gaming key cannot meet the needs of high-demanding users.

### SUMMARY

To solve the above problem, objectives of the present disclosure are to provide a switch having an adjustable key travel, a gaming peripheral including the switch, and a method for adjusting the switch.

The present disclosure achieves the above purposes by means of the following technical solutions:

In the first aspect, the present disclosure provides a key travel adjustable switch, including a snap fastener, a switch cap clamped to the snap fastener and having a travel positioning portion, a switch cap silicone between the switch cap and the snap fastener, and a switch body having a plurality of travel adjusting portions of different heights. A key travel of the key travel adjustable switch may be adjustable by positioning the travel positioning portion at different travel adjusting portions of different heights.

The above technical solution is used. When the key travel adjustable switch of the present disclosure is in use, the travel positioning portion may be pried out from the travel adjusting portion, namely, the switch cap may be made to be separated from the switch body, then by rotating the switch cap and/or the switch body at a certain angle, the travel positioning portion may match with another travel adjusting portion of a different height, so as to adjust the key travel of the key travel adjustable switch.

In one or more embodiments, the travel positioning portion may be a positioning clamping pin, the travel adjusting portions may be positioning clamping grooves, and the positioning clamping pin may be snapped in the positioning clamping grooves. In one or more embodiments, two types of positioning clamping grooves of different heights may be provided, a number of each type of positioning clamping grooves may be two, the four positioning clamping grooves may be provided at equal angles along a circumferential direction of the switch body, and two adjacent positioning clamping grooves are of different heights; and the positioning clamping pin on a side edge of the switch cap may be provided in correspondence with the positioning clamping groove.

In one or more embodiments, a plurality of side plates may be further formed on the side edge of the switch cap, and each side plate may be provided with a clamping hole.

In one or more embodiments, positioning bumps and limiting bumps may be formed on a side edge of the snap fastener, each of the positioning bumps may be clamped to a corresponding clamping hole provided in the side plate, and the limiting bump may be clamped to a gap between two adjacent side plates.

In one or more embodiments, the switch cap may be made from a transparent material.

In one or more embodiments, a range of the key travel may be 0.1 mm to 3 mm.

In one or more embodiments, a number of the plurality of travel adjusting portions may be from 2 to 10.

In one or more embodiments, the key travel adjustable switch may be a keyboard key, a gamepad switch, or an arcade game switch.

In one or more embodiments, a micro switch may be further included, where the micro switch is at least partially provided in the switch body, and the micro switch may be triggered by moving the switch cap downwards by a corresponding key travel, where the corresponding key travel is according to a corresponding travel adjusting portion that the travel positioning portion is positioned at.

In the second aspect, the present disclosure provides a gaming peripheral including the key travel adjustable switch described above.

In the third aspect, the present disclosure provides a method for adjusting the key travel adjustable switch described above. The method may include positioning the travel positioning portion at different travel adjusting portions of different heights to adjust the key travel of the key travel adjustable switch.

In summary, the present disclosure has the beneficial effects that a structure in which the switch cap is clamped to the switch body is used, and the switch body is provided with the travel adjusting portions of different heights. When the key travel adjustable switch is in use, by prying open a matching structure of the travel positioning portion of the switch cap and the travel adjusting portion on the switch body, by means of rotation at a certain angle, the travel positioning portion matches with the different travel adjusting portions, and then the key travel may be adjusted, so that a response speed of the key travel adjustable switch may be adjusted, thereby meeting requirements of a user.

### BRIEF DESCRIPTION OF FIGURES

To describe the technical solutions in embodiments of the present disclosure or the prior art more clearly, the following briefly describes the accompanying drawings required for describing the embodiments or the prior art. Apparently, the accompanying drawings in the following description show only some embodiments of the present disclosure, and a person of ordinary skill in the art may still derive other accompanying drawings from the accompanying drawings without creative efforts.

FIG. 1 is a front view of a switch of the present disclosure;

FIG. 2 is an A-A cross-sectional view of FIG. 1;

FIG. 3 is an axonometric view of FIG. 1;

FIG. 4 is an exploded view of the switch of the present disclosure;

FIG. 5 is a front view of a switch cap of the present disclosure;

FIG. 6 is an axonometric view of FIG. 5;

FIG. 7 is a front view of a snap fastener of the present disclosure; and

FIG. 8 is an axonometric view of FIG. 7.

### LIST OF REFERENCE NUMERALS

1: switch cap; 101: travel positioning portion; 102: side plate; 103: clamping hole; 2: switch cap silicone; 3: snap fastener; 301: limiting bump; 302: positioning bump; 4: switch body; and 401: travel adjusting portion.

### DETAILED DESCRIPTION

To make the objectives, technical solutions, and advantages of the present disclosure clearer, the following describes the technical solutions of the present disclosure in detail. Obviously, the embodiments described are only some example embodiments representing a part of the embodiments of the present disclosure, rather than all of the embodiments. All other embodiments obtained by a person of ordinary skill in the art based on the embodiments in the present disclosure without creative efforts shall fall within the protection scope of the present disclosure.

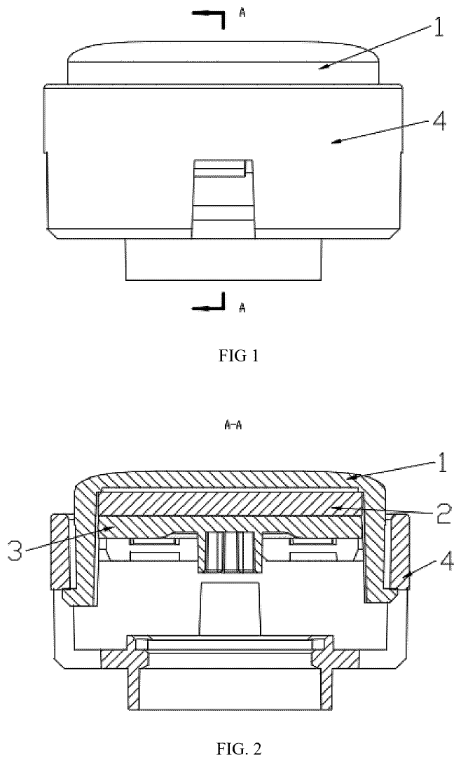

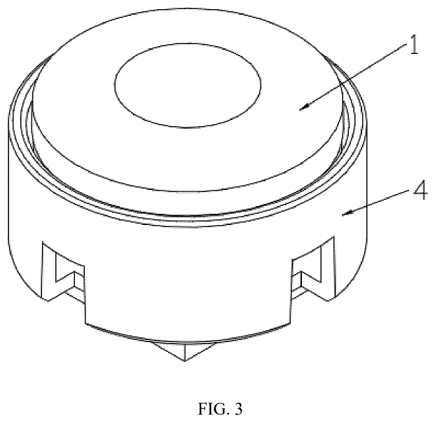

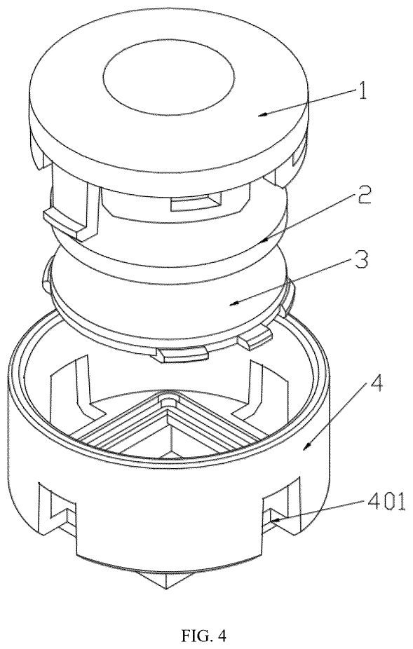

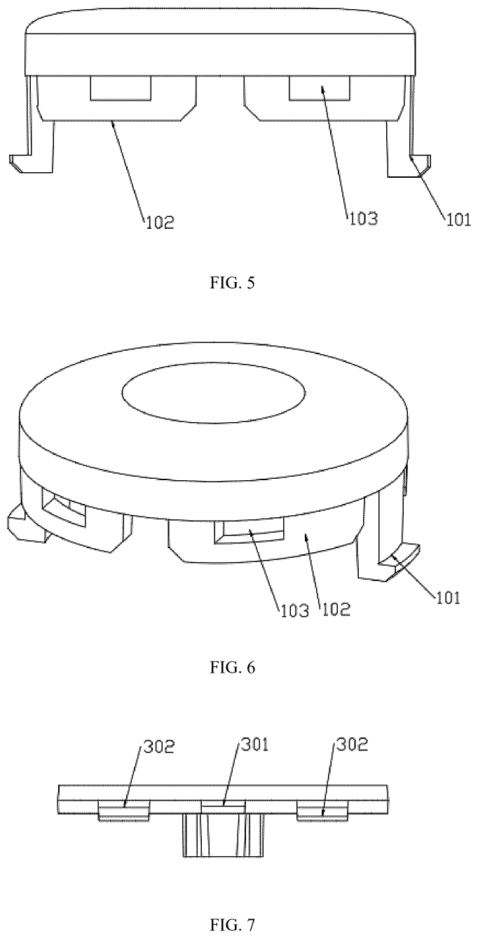

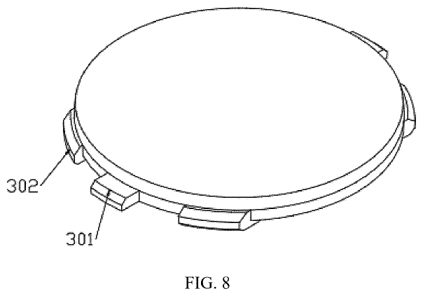

With reference to FIG. 1 to FIG. 8, the present disclosure provides a switch having an adjustable key travel (hereinafter referred to as an adjustable switch sometimes). The switch may include a switch cap 1, switch cap silicone 2, a snap fastener 3, and a switch body 4. As used herein, the term “switch” may be a key, a button, or a switch that is actuated/triggered to change its state. A switch actuation of the switch may be occurred by any suitable physical interaction with the switch which may cause a mechanical linkage inside the switch to come into, or go out of, contact. For example, a physical interaction may be pushing, sliding, rotating, pulling, heating, and/or magnetizing. In one or more embodiments, the switch may be a magnetic switch, a capacitive switch, and a hall effect switch. In one or more embodiments, the switch may be a momentary push-down switch.

Furthermore, the adjustable switch may further include a micro switch. The micro switch may be at least partially provided in the switch body 4. The switch cap 1 may be moved downwards by a predetermined key travel, for example, a key travel to trigger the micro switch. In one or more embodiments, the switch cap 1 may be made from a transparent material.

In one or more embodiments, the switch cap 1 may be clamped to the snap fastener 3. The switch cap silicone 2 may be provided between the switch cap 1 and the snap fastener 3. The snap fastener 3 may be fixedly connected to the micro switch. The switch cap 1 may be provided with a travel positioning portion 101, the switch body 4 may be provided with a plurality of travel adjusting portions 401 of different heights, and the travel positioning portion 101 may match with the travel adjusting portions 401 of different heights to adjust the adjustable key travel. When the switch is in use, the travel positioning portion 101 may be separated from the travel adjusting portion 401, for example, the travel positioning portion 101 may be pried out from the travel adjusting portion 401, and then by means of a rotation of the travel positioning portion 101 at a certain angle, the travel positioning portion 101 may match with another travel adjusting portion 401 that is of a different height from the previous travel adjusting portion 401, so as to adjust the adjustable key travel of the switch.

In one or more embodiments of the present disclosure, the travel positioning portion 101 may be a positioning clamping pin, the travel adjusting portions 401 may be positioning clamping grooves, and the positioning clamping pin may be fitted to the positioning clamping grooves, for example, the position clamping pin may be snapped to the positioning clamping grooves. In one or more embodiments, two types of positioning clamping grooves of different heights may be provided, and a number of each type of positioning clamping grooves may be two, therefore, four positioning clamping grooves may be provided at equal angles along a circumferential direction of the switch body 4, and two adjacent positioning clamping grooves may be of different heights, that is, two adjacent positioning clamping grooves may form an angle of 90 degrees. In response to a number of the positioning clamping groove, the positioning clamping pin on a side edge of the switch cap 1 may be provided correspondingly. When the switch is in use, the positioning clamping pin on the switch cap 1 may be pried out from the positioning clamping groove, such that the switch cap 1 may be separated from the switch body 4, and then the switch cap 1 may be rotated by an angle, e.g., 90 degrees, to match with another set of two positioning clamping grooves. Two positions (e.g., the positioning clamping grooves of two different heights) may be provided so as to adjust the adjustable key travel of the switch.

Furthermore, a plurality of side plates 102 may be further formed on the side edge of the switch cap 1, and each of the plurality of side plates 102 may be provided with a clamping hole 103. Positioning bumps 302 and limiting bumps 301 may be formed on a side edge of the snap fastener 3, each of the positioning bump 302 may be clamped to the clamping hole 103 provided in the side plate 102, and each of the limiting bump 301 may be clamped to a gap between two adjacent side plates 102. By means of the structural design, a stable cooperation between the switch cap 1 and the snap fastener 3 may be provided.

In summary, a structure in which the switch cap 1 is clamped to the switch body 4 may be used, and the switch body 4 may be provided with the travel adjusting portions 401 of different heights. When the switch is in use, by prying open a matching structure of the travel positioning portion 101 of the switch cap 1 and the travel adjusting portion 401 on the switch body 4, through rotating an angle of the switch cap 1 and/or the switch body 1, the travel positioning portion 101 may match with a different travel adjusting portion 401 (or a different set of travel adjusting portions 401), and the adjustable key travel of the switch may be adjusted, so that a response speed of the switch may be adjusted, thereby meeting requirements of a user.

Furthermore, a range of the adjustable key travel may be from 0.1 mm to 3 mm. In one or more embodiments, the adjustable key travel may be a distance by which the switch cap 1 is moved downwards when the switch is being pressed. In one embodiment, the range of the adjustable key travel may be 0.5 mm to 1.5 mm. More specifically, the range of the adjustable key travel may be 0.8 mm to 1.2 mm. For example, three adjustable key travels may be provided within a distance ranging from 0.8 mm to 1.2 mm, which may include a first key travel of 0.8 mm, a second key travel of 1.0 mm, and a third key travel of 1.2 mm.

Furthermore, a number of the plurality of travel adjusting portions 401 may be from 2 to 10.

Furthermore, the adjustable switch of the present disclosure may be a keyboard key, a gamepad switch, or an arcade game switch.

The present disclosure provides a gaming peripheral, which may include the adjustable switch described above.

The present disclosure further provides a method for adjusting the adjustable switch described above. In one or more embodiments, the method may include positioning the travel positioning portion at different travel adjusting portions of different heights to adjust the adjustable key travel of the switch.

What is described above is only a specific embodiment of the present disclosure, but the protection scope of the present disclosure is not limited thereto, and any person skilled in the art can readily conceive of changes or substitutions within the technical scope disclosed in the present disclosure, all of which shall fall within the protection scope of the present disclosure. Therefore, the protection scope of the present disclosure shall be subject to the appended claims.

What is claimed is:

1. A key travel adjustable switch, comprising:
a snap fastener;
a switch cap clamped to the snap fastener and having a travel positioning portion;
a switch cap silicone between the switch cap and the snap fastener; and
a switch body having a plurality of travel adjusting portions of different heights,
wherein a key travel of the key travel adjustable switch is adjustable by positioning the travel positioning portion at different travel adjusting portions of different heights.

2. The key travel adjustable switch according to claim 1, wherein the travel positioning portion is a positioning clamping pin, the plurality of travel adjusting portions is positioning clamping grooves, and the positioning clamping pin is snapped in the positioning clamping grooves;
wherein two types of positioning clamping grooves of different heights are provided, a number of each type of positioning clamping grooves is two, the four positioning clamping grooves are provided at equal angles along a circumferential direction of the switch body, and two adjacent positioning clamping grooves are of different heights; and the positioning clamping pin on a side edge of the switch cap is provided in correspondence with the positioning clamping grooves.

3. The key travel adjustable switch according to claim 2, wherein a plurality of side plates is further formed on the side edge of the switch cap, and each side plate is provided with a clamping hole.

4. The key travel adjustable switch according to claim 3, wherein a positioning bump and a limiting bump are formed on a side edge of the snap fastener, the positioning bump is clamped to the clamping hole provided in each side plate, and the limiting bump is clamped to a gap between two adjacent side plates.

5. The key travel adjustable switch according to claim 1, wherein the switch cap is made from a transparent material.

6. The key travel adjustable switch according to claim 1, wherein the key travel of the key travel adjustable switch ranges from 0.1 mm to 3 mm.

7. The key travel adjustable switch according to claim 1, wherein a number of the plurality of travel adjusting portions is from 2 to 10.

8. The key travel adjustable switch according to claim 1, wherein the key travel adjustable switch is a keyboard key, a gamepad switch, or an arcade game switch.

9. The key travel adjustable switch according to claim 1, further comprising a micro switch, wherein the micro switch is at least partially provided in the switch body, and the micro switch is triggered by moving the switch cap downwards by a corresponding key travel, wherein the corresponding key travel is according to a corresponding travel adjusting portion that the travel positioning portion is positioned at.

10. A gaming peripheral, comprising a key travel adjustable switch, wherein the key travel adjustable switch comprises:
a snap fastener;
a switch cap clamped to the snap fastener and having a travel positioning portion;
a switch cap silicone between the switch cap and the snap fastener; and
a switch body having a plurality of travel adjusting portions of different heights,
wherein a key travel of the key travel adjustable switch is adjustable by positioning the travel positioning portion at different travel adjusting portions of different heights.

11. The gaming peripheral according to claim 10, wherein the travel positioning portion is a positioning clamping pin, the plurality of travel adjusting portions is positioning clamping grooves, and the positioning clamping pin is snapped in the positioning clamping grooves;
wherein two types of positioning clamping grooves of different heights are provided, a number of each type of positioning clamping grooves is two, the four positioning clamping grooves are provided at equal angles along a circumferential direction of the switch body, and two adjacent positioning clamping grooves are of different heights; and the positioning clamping pin on a side edge of the switch cap is provided in correspondence with the positioning clamping grooves.

12. The gaming peripheral according to claim 11, wherein a plurality of side plates is further formed on the side edge of the switch cap, and each side plate is provided with a clamping hole.

13. The gaming peripheral according to claim 12, wherein a positioning bump and a limiting bump are formed on a side edge of the snap fastener, the positioning bump is clamped to the clamping hole provided in each side plate, and the limiting bump is clamped to a gap between two adjacent side plates.

14. The gaming peripheral according to claim 10, wherein the switch cap is made from a transparent material.

15. The gaming peripheral according to claim 10, wherein the key travel ranges from 0.1 mm to 3 mm.

16. The gaming peripheral according to claim 10, wherein a number of the plurality of travel adjusting portions is from 2 to 10.

17. The gaming peripheral according to claim 10, wherein the key travel adjustable switch is a keyboard key, a gamepad switch, or an arcade game switch.

18. The gaming peripheral according to claim 10, wherein the key travel adjustable switch further comprises a micro switch, wherein the micro switch is at least partially provided in the switch body, and the micro switch is triggered by moving the switch cap downwards by a corresponding key travel, wherein the corresponding key travel is according to a corresponding travel adjusting portion that the travel positioning portion is positioned at.

19. A method for adjusting a key travel adjustable switch, wherein the key travel adjustable switch comprises:
a snap fastener;
a switch cap clamped to the snap fastener and having a travel positioning portion;
a switch cap silicone between the switch cap and the snap fastener; and
a switch body having a plurality of travel adjusting portions of different heights, the method comprising:
positioning the travel positioning portion at different travel adjusting portions of different heights to adjust a key travel of the key travel adjustable switch.

20. The method according to claim 19, wherein the key travel adjustable switch comprises a micro switch at least partially provided in the switch body, the method comprising:
moving the switch cap downwards by a corresponding key travel to trigger the micro switch, wherein the corresponding key travel is according to a corresponding travel adjusting portion that the travel positioning portion is positioned at.
